(19) United States
(12) Patent Application Publication
(10) Pub. No.: US 2009/0138862 A1
(43) Pub. Date: May 28, 2009

(54) PROGRAM PARALLELIZATION SUPPORTING APPARATUS AND PROGRAM PARALLELIZATION SUPPORTING METHOD

(75) Inventors: Ken Tanabe, Tokyo (JP); Yutaka Ota, Kanagawa (JP); Nobu Matsumoto, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/211,420

(22) Filed: Sep. 16, 2008

(30) Foreign Application Priority Data
Nov. 22, 2007 (JP) 2007-303331

(51) Int. Cl. G06F 9/45

(52) U.S. Cl. 717/149

(57) ABSTRACT

A program parallelization supporting apparatus determines a determinacy in at least one dependency relationship of a data dependency, a control dependency and a pointer dependency in a program, extracts a critical path in the program, and extracts a processing instruction which exists on the critical path and has a non-deterministic determinacy in the dependency relationship. Furthermore, if a process related to a path of the extracted non-deterministic processing instruction is parallelized and the path of the non-deterministic processing instruction is deleted, the program parallelization supporting apparatus outputs parallelization labor hour information depending on the number of dependency relationships disturbing the parallelization and parallelization effect information depending on the number of processing instructions which are shortened by the parallelization.

### CROSS REFERENCE TO RELATED APPLICATION

This application is based upon and claims the benefit of priority from the prior Japanese Application No. 2007-303331 filed on Nov. 22, 2007; the entire contents of which are incorporated herein by reference.

### BACKGROUND OF THE INVENTION

1. Field of the Invention

The present invention relates to a program parallelization supporting apparatus and a program parallelization supporting method, and more particularly to a program parallelization supporting apparatus and a program parallelization supporting method which support a user in efficiently performing program parallelization.

2. Description of the Related Art

Conventionally, an automatic program parallelization method has been proposed. However, since a dependency relationship analysis in which a parallelizable section is extracted has to be performed full-automatically and minutely, variable limitations in a sequentially executed program targeted for parallelization are imposed on a program developer. The limitations include, for example, prohibition of using a function pointer, prohibition of dynamically securing a memory, and forcing of extended-descriptions for adding necessary information.

On the other hand, if the parallelization of the program is manually performed there is, for example, a method of effectively comprehending the parallelizable section and a dependency relationship disturbing the parallelization by concurrently using a method of representing a dependency relationship between functions in the program by using a call graph, a method of representing a dependency relationship between statements by using a control data flow graph (CDFG), a program slicing method of extracting a statement including a dependency relationship with a specific statement in the program by generating a system dependency graph and performing vertex search, and the like.

However, if these methods are applied to an analysis of a large-scale, sequentially executed program, for example, since relationships between the functions include various relationships, the various relationships are mixed and displayed or listed. Therefore, an analysis task becomes vast and cumbersome for an analyst. For example, relationships between two functions include a relationship in which the functions are always dependent on each other, a relationship in which the functions are dependent on each other depending on a condition of a parameter or the like, and a relationship in which the analysis cannot be performed sufficiently and thus the functions are displayed to be dependent for safety.

Therefore, in the case of the large-scale program, since the various relationships are mixed and displayed on a display screen, for the program developer, there are too many dependency relationships to be carefully examined for improving a degree of parallelism, and a task for improving the degree of parallelism becomes vast. Therefore, there is a problem in which a program parallelization task becomes practically impossible.

Moreover, for example, Japanese Patent Application Laid-Open Publication No. 2005-267024 and Japanese Patent Application Laid-Open Publication No. 7-36680 have disclosed a technique in which, when a program parallelization process is performed, parallelization of a process in units of program blocks is performed to attempt acceleration of the process in units of program blocks.

However, even if the technique according to such proposals is used, since a large amount of information is outputted in the case of the large-scale program as described above, there is still a problem in which the analysis task for improving the degree of parallelism becomes vast and cumbersome for the developer.

### SUMMARY OF THE INVENTION

According to an embodiment of the present invention, a program parallelization supporting apparatus can be provided, including a determinacy determining unit configured to determine a determinacy in at least one dependency relationship of a data dependency, a control dependency and a pointer dependency in a program, a critical path extracting unit configured to extract a critical path in the program, a processing instruction extracting unit configured to extract a processing instruction which exists on the critical path and has a non-deterministic determinacy in the dependency relationship in the determinacy determining unit, and a parallelization information outputting unit configured to, if a process related to a path of the extracted non-deterministic processing instruction is parallelized and the path of the non-deterministic processing instruction is deleted, output parallelization labor hour information depending on the number of dependency relationships disturbing the parallelization and parallelization effect information depending on the number of processing instructions which are shortened by the parallelization.

According to an embodiment of the present invention, a program parallelization supporting method cane be provided, including determining a determinacy in at least one dependency relationship of a data dependency, a control dependency and a pointer dependency in a program, extracting a critical path in the program, extracting a processing instruction which exists on the critical path and has a non-deterministic determinacy in the dependency relationship, and if a process related to a path of the extracted non-deterministic processing instruction is parallelized and the path of the non-deterministic processing instruction is deleted, outputting parallelization labor hour information depending on the number of dependency relationships disturbing the parallelization and parallelization effect information depending on the number of processing instructions which are shortened by the parallelization.

### BRIEF DESCRIPTION OF THE DRAWINGS

FIG. 1 is a configuration diagram showing a configuration of a program parallelization supporting apparatus according to a first embodiment of the present invention;

FIG. 2 is a diagram showing an example of a program configured to read multiple pieces of data and output data applied with a predetermined process, according to the first embodiment of the present invention;

FIG. 3 is a flowchart showing an example of a flow of a process in a parallelization support processing program in the parallelization supporting apparatus according to the first embodiment of the present invention;

FIG. 4 is a diagram showing an example of an inter-statement dependency relationship information database according to the first embodiment of the present invention;

FIG. 5 is a diagram illustrating processing contents of a static dependency relationship analysis in a static dependency relationship analyzing unit of FIG. 3;

FIG. 6 is a flowchart showing an example of a flow of a process related to determination of a determinacy in a determinacy analyzing unit according to the first embodiment of the present invention;

FIG. 7 is a flowchart showing an example of a flow of a process related to the determination of the determinacy in a control dependency relationship analyzing unit according to the first embodiment of the present invention;

FIG. 8 is a flowchart showing an example of a flow of a process related to the determination of the determinacy in another determinacy analyzing unit according to the first embodiment of the present invention;

FIG. 9 is a diagram illustrating processing contents in a parallelization possibility analyzing unit according to the first embodiment of the present invention;

FIG. 10 is a diagram showing an example of a processing program in the parallelization possibility analyzing unit shown in FIG. 9;

FIG. 11 is a diagram showing a display example of a screen of a displaying device of the parallelization supporting apparatus according to the first embodiment of the present invention;

FIG. 12 is a diagram showing a display example of a dependency relationship graph to be displayed on a dependency relationship graph displaying unit of the displaying device according to the first embodiment of the present invention;

FIG. 13 is a diagram showing a display example of a block level display of the dependency relationship graph according to the first embodiment of the present invention;

FIG. 14 is a diagram showing a display example of the dependency relationship graph in which, with respect to arbitrary functions, a display of dependency relationships of the functions on the dependency relationship graph has been omitted in blocks, according to the first embodiment of the present invention;

FIG. 15 is a diagram showing a display example of a dependency relationship graph loop two-stage loop expansion display according to the first embodiment of the present invention;

FIG. 16 is a diagram showing a display example of a critical path-highlighted display according to the first embodiment of the present invention;

FIG. 17 is a diagram showing a display example of the dependency relationship graph after a dependency relationship has been invalidated, according to the first embodiment of the present invention;

FIG. 18 is a flowchart showing an example of the flow of the process in the parallelization supporting apparatus according to a second embodiment of the present invention;

FIG. 19 is a diagram showing an example of a program for which parallelization is desired, according to the second embodiment of the present invention; and

FIG. 20 is a diagram illustrating dependency relationship information in which the program has been executed and dependency relationships in the execution of the program have been generated from profile information, according to the second embodiment of the present invention.

### DETAILED DESCRIPTION OF THE EMBODIMENTS

Hereinafter, embodiments of the present invention will be described with reference to the drawings.

### First Embodiment

1. Overall Configuration

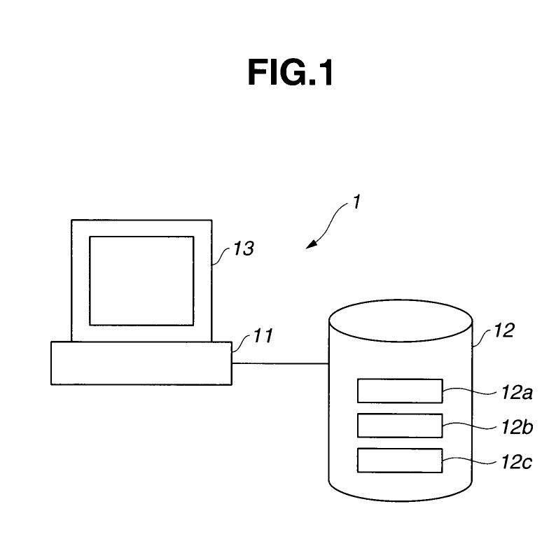

First, a configuration of a program parallelization supporting apparatus according to a first embodiment of the present invention will be described. FIG. 1 is a configuration diagram showing the configuration of the program parallelization supporting apparatus according to the present embodiment.

A program parallelization supporting apparatus (hereinafter simply referred to as “parallelization supporting apparatus”) 1 has a configuration including a computer main body 11 such as a personal computer (PC), a storage device 12 configured to store various programs and data to be described below, and a displaying device 13 configuring a graphical user interface (GUI).

In the storage device 12, a program targeted for parallelization 12a, an inter-statement dependency relationship information database 12b to be described below, and a parallelization support processing program 12c according to the present embodiment are stored.

A developer (hereinafter also referred to as “user”) who performs the parallelization of the program can use the parallelization supporting apparatus 1, operate an inputting device (not shown) such as a keyboard or a mouse to issue instructions for various processes to the program targeted for the parallelization, and thereby perform an analysis process and the like as described below.

It should be noted that although the parallelization supporting apparatus 1 of FIG. 1 is a computer apparatus such as a PC, the parallelization supporting apparatus 1 may be a system which is connected to a network and has a configuration in which a center device such as a server is caused to execute functions to be described below and the user issues the instructions for the various processes from a client such as a PC.

2. Program Example

An example is used for the following description. For simplicity of the description, with an example of a simple program, a case where the program is parallelized for a multiprocessor will be described.

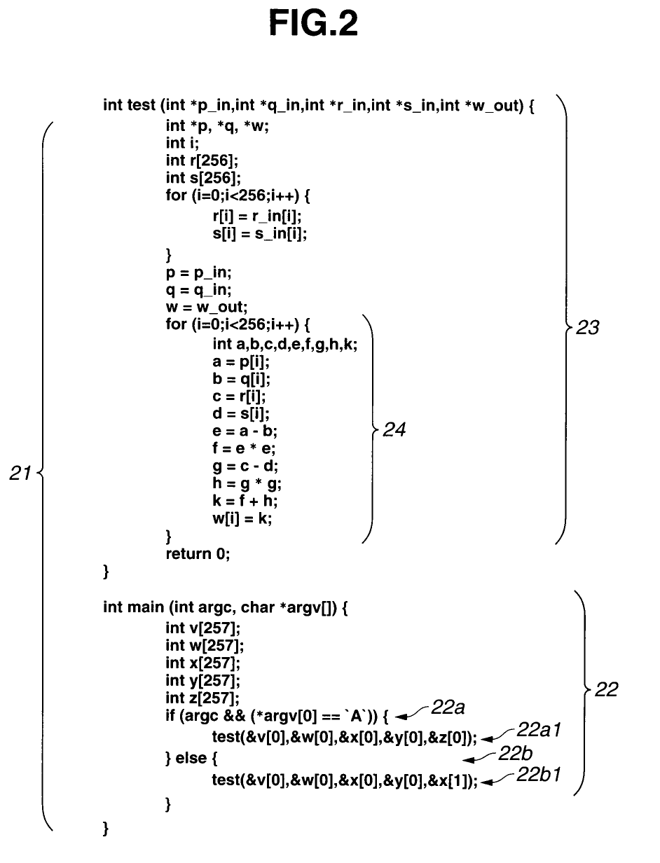

FIG. 2 is a diagram showing an example of a program configured to read multiple pieces of data and output data applied with a predetermined process. Here, a sequentially described program of FIG. 2 is parallelized for a multiprocessor system configured with one host processor and multiple parallel arithmetic processors. The multiprocessor which executes the program may be either a heterogeneous multiprocessor or a homogeneous multiprocessor.

A program 21 is a program configured to perform a process of reading four pieces of input data from predetermined memory areas, applying a predetermined arithmetic process thereto, and writing output data in a predetermined memory area. As shown in FIG. 2, when the program 21 is executed, the four pieces of input data are read from four storage areas p, q, r and s, and the output data is written in a storage area w.

The program 21 can be roughly divided into a program section of main 22 and a program section of a function of int test 23. Furthermore, the program section 23 includes a program section of a for statement 24.

In the program section of main 22, there is an if statement, and when a predetermined condition has been met (a case 22a), a processing instruction 22a1 for the function of int test using predetermined input data is executed. When the predetermined condition is not met (a case 22b), a processing instruction 22b1 for the function of int test using predetermined input data which is different from the input data for the processing instruction 22a1 is executed.

In the program 21, there are several dependency relationships. For example, in the program section of main 22, with the processing instruction 22b1, an arithmetic process is performed 256 times for array data x[ ] in which array data x[0] is read as one piece of the input data and written in array data x[1], and subsequently, similarly, array data x[1] is read and written in array data x[2], and the like.

Therefore, in the processing instruction 22b1, there is a data dependency relationship for the array data x[ ] in which an arithmetic process using a next piece of the array data x[ ] cannot be executed until a previous arithmetic process is completed. Conversely, since there is the dependency relationship, a parallelization cannot be performed for the processing instruction 22b1. Other dependency relationships in the program 21 will be described below.

3. Overall Flow of Parallelization Supporting Process

The parallelization supporting apparatus 1 has a function configured to analyze statements in the program 21 and extract a dependency relationship between the statements.

Next, a flow of a process in the parallelization supporting apparatus 1 will be described. The process in the parallelization supporting apparatus 1 is executed by a central processing unit (CPU) such as a PC.

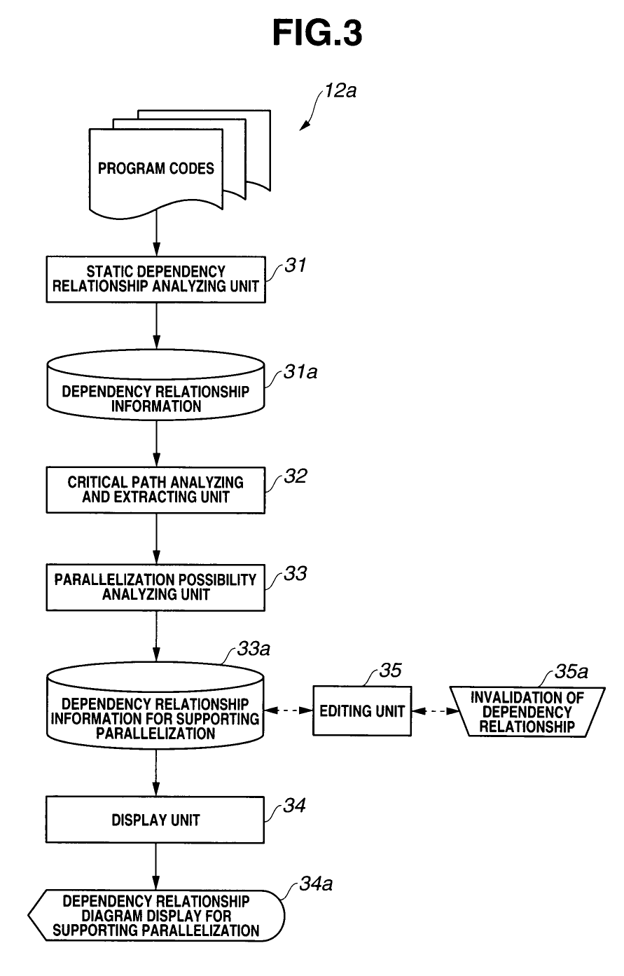

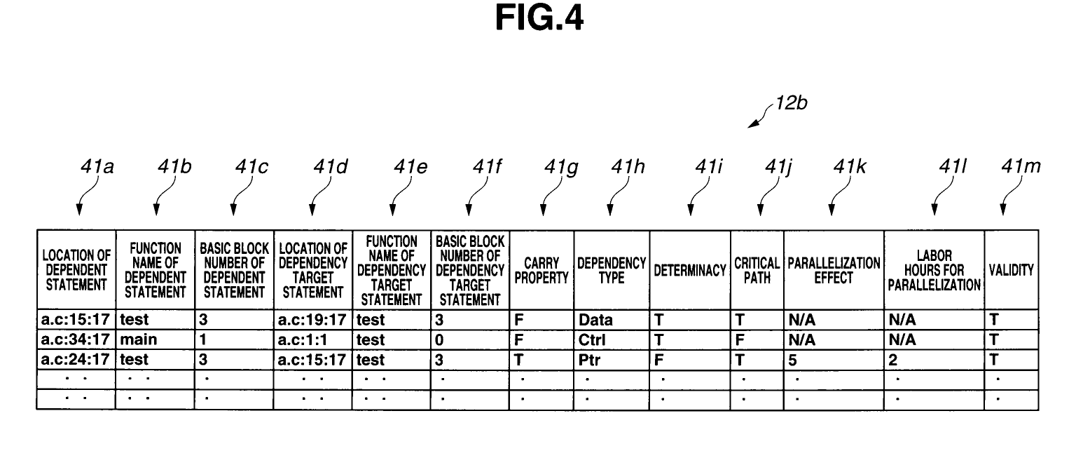

FIG. 3 is a flowchart showing an example of a flow of a process in the parallelization support processing program 12c in the parallelization supporting apparatus 1 according to the present embodiment. FIG. 4 is a diagram showing an example of the inter-statement dependency relationship information database.

As shown in FIG. 3, in the parallelization supporting apparatus 1, first, program codes for the multiprocessor to be analyzed (hereinafter also simply referred to as “program”) 12a are read. A static dependency relationship analyzing unit 31 performs a static analysis for the inputted program 12a, and thereby performs a process of a static dependency relationship analysis configured to analyze the dependency relationship between the statements (hereinafter referred to as “inter-statement dependency relationship”) in the program. Hereinafter, an example in the case where the program 12a is the above described program 21 will be described.

3.1 Static Dependency Relationship Analysis

The static dependency relationship analyzing unit 31 registers a result of the static dependency relationship analysis as dependency relationship information 31a in the inter-statement dependency relationship information database 12b of FIG. 4.

Here, processing contents in the static dependency relationship analyzing unit 31 will be described.

The static dependency relationship analyzing unit 31 analyzes the program codes line by line, and extracts a statement with a dependency relationship, that is, a processing instruction. For example, it is detected that there is a data dependency relationship (Data) between a statement of “a=p[i];” on line 15 and a statement of “e=a-b;” on line 19 in the program 21. Such a dependency relationship analysis is performed for all lines, that is, all statements, and only for the statement with the dependency relationship, the dependency relationship information is extracted and registered in the inter-statement dependency relationship information database 12b.

### (Configuration of Inter-Statement Dependency Relationship Information Database)

When an inter-statement dependency relationship is detected, the information is registered in the inter-statement dependency relationship information database 12b shown in FIG. 4. The inter-statement dependency relationship information database 12b of FIG. 4 is data in a tabular format. The inter-statement dependency relationship information database 12b has respective fields 41a to 41m of a location of a dependent statement, a function name of the dependent statement, a basic block number of the dependent statement, a location of a dependency target statement, a function name of the dependency target statement, a basic block number of the dependency target statement, a carry property, a dependency type, a determinacy, a critical path, a parallelization effect, labor hours for parallelization, and validity. Each piece of the dependency relationship information to be registered in the inter-statement dependency relationship information database 12b has information on respective items.

In the fields of the items of the function names 41b and 41e, the function name to which the statement belongs is recorded. In the fields of the items of the basic block numbers 41c and 41f, the basic block number to which the statement belongs is recorded.

It should be noted that the block number is determined here according to a rule in which, if there is a for statement or the like in the program 21, a section of the for statement is regarded as one block, or the like. For example, here, the block numbers are determined as follows: lines 6 to 9 (for statement) is a first block, lines 10 to 12 is a second block, and lines 13 to 25 (for statement) is a third block, in the program 21.

The field of the item of the carry property 41g is recorded if there is a data dependency relationship for a static variable which is defined near a function exit and used when next and subsequent functions are invoked, a data dependency relationship for a variable which is defined near a loop exit and used in next and subsequent loop iterations, or the like. Therefore, in the item of the carry property, in the case of the inter-statement dependency relationship in a loop, the carry property is nonexistent, that is, “F”. In the case of the inter-statement dependency relationship between loops, the carry property is existent, that is, “T”.

In the field of the item of the dependency type 41h, any of dependency relationship types of a control dependency (Ctrl) which is a dependency relationship from a control statement such as an if statement or a while statement to a controlled statement, a data dependency (Data) indicating a dependency relationship from a statement which defines a value for a variable to a statement which uses the value, and a pointer dependency (Ptr) indicating a dependency relationship from a definition of a value of a variable indicating a position on a memory, such as a pointer variable, to a statement indicating a value pointed by the same pointer variable or another pointer variable with an alias, is recorded. In the field of the item of the determinacy 41i, whether the dependency relationship is a deterministic dependency relationship which is constantly established or a non-deterministic dependency relationship which may not always be dependent is recorded.

In the field of the item of the critical path 41j, whether or not a watched statement exists on a critical path (CP) from a start point to an end point in the program is recorded.

In the field of the item of the parallelization effect 41k, in the case of the dependency relationship which is on the critical path (CP) and is non-deterministic, if all non-deterministic dependency relationships in dependency relationships on another critical path (CP) in parallel with the dependency relationship have been able to be invalidated, a length or the number of stages of the critical path (CP) which is shortened by rescheduling is recorded.

In a section of the field of the item of the labor hours for parallelization 41l, the number of paths in a dependency relationship required to be invalidated for realizing the parallelization related to a watched dependency relationship is recorded. Specifically, if a path in the watched dependency relationship is on the critical path (CP) and is further non-deterministic, a value obtained by adding 1 to the number of paths in another parallel critical path (CP) is recorded. It should be noted that if a deterministic critical path (CP) is in parallel, the labor hours become infinity here. The field of the item of the validity 41m will be described below.

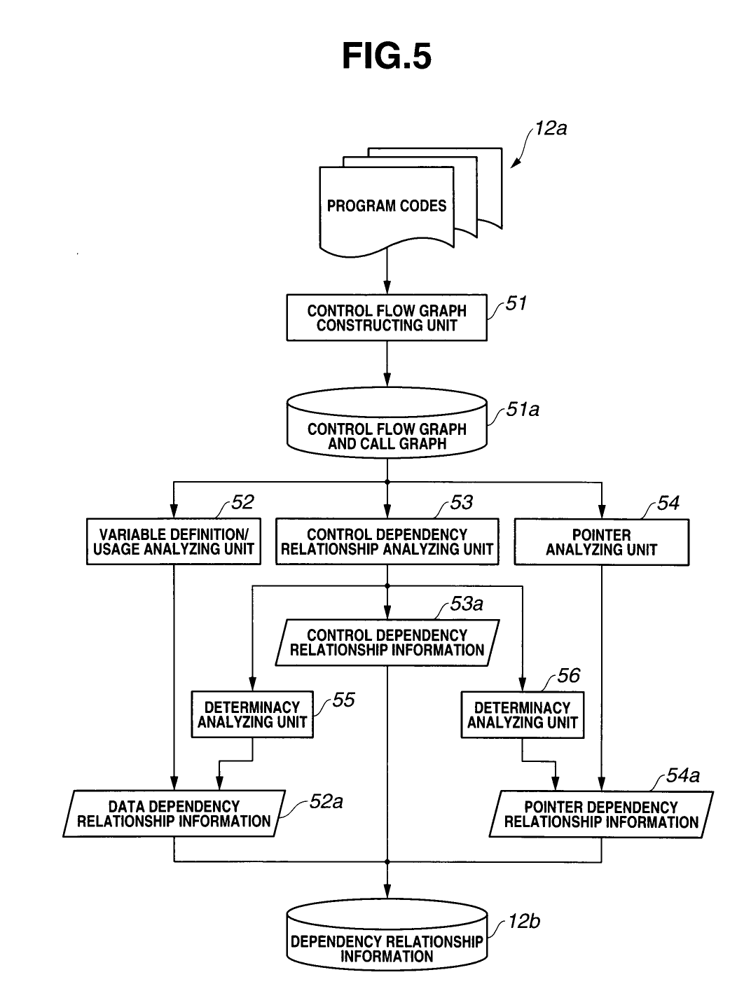

FIG. 5 is a diagram illustrating the processing contents of the static dependency relationship analysis in the static dependency relationship analyzing unit 31 of FIG. 3.

First, when the program codes 12a are read, a control flow graph constructing unit 51 executes a process of constructing a control data flow graph and a call graph. Hence, the control flow graph constructing unit 51 also includes a call graph constructing unit.

Information 51a on a control flow graph (CFG) and a call graph (CG) i generated by the process in the control flow graph constructing unit 51.

Next, based on the generated information on the control flow graph (CFG), analyses of three dependency relationships are executed.

Processes of analyzing the three dependency relationships are executed by a variable definition/usage analyzing unit 52, a control dependency relationship analyzing unit 53 and a pointer analyzing unit 54, respectively. The variable definition/usage analyzing unit 52, the control dependency relationship analyzing unit 53 and the pointer analyzing unit 54 use the information on the control flow graph (CFG) to analyze the dependency relationships, and register the dependency relationship information obtained as results of the analyses, in the inter-statement dependency relationship information database 12b, respectively.

3.1.1 Data Dependency Relationship Analysis

The variable definition/usage analyzing unit 52 analyzes and determines whether or not there is a data dependency relationship (Data), based on information on variables, from the information on the control flow graph (CFG). For example, it is determined that there is a data dependency relationship (Data) between the statement of “a=p[i];” on line 15 and the statement of “e=a-b;” on line 19 in the for statement in the program 21 of FIG. 2.

For example, a fact that there is the data dependency relationship (Data) between the statement of “a=p[i];” on line 15 and the statement of “e=a-b;” on line 19 in the above described program 21 has been registered as the dependency relationship information on line 1 of the inter-statement dependency relationship information database 12b.

In other words, on line 1 of FIG. 4, the field of the location of the dependent statement 41a indicates that the statement is in a file name of “a.c”, on line 15 of the program, and from character 17 from the left on line 15. The field of the function name of the dependent statement 41b indicates that the function name is “test”. The field of the basic block number of the dependent statement 41c indicates that the basic block number is “3”. The field of the location of the dependency target statement 41d indicates that the statement is in a file name of “a.c”, on line 19 of the program, and from character 17 from the left on line 19. The field of the function name of the dependency target statement 41e indicates that the function name is “test”. The field of the basic block number of the dependency target statement 41f indicates that the basic block number is “3”.

Furthermore, a fact that the carry property is nonexistent “F”, the dependency type is the data dependency “Data”, and the determinacy is existent “T” has been recorded. An analysis of the determinacy will be described below.

3.1.2 Control Dependency Relationship Analysis

The control dependency relationship analyzing unit 53 analyzes and determines whether or not there is a control dependency relationship (Ctrl), based on whether or not a predetermined instruction such as the if statement exists, from the information on the control flow graph (CFG). In the program section 22 of FIG. 2, since there is an if statement and the process jumps to another basic block from a statement following the if statement, it is determined that there is a control dependency relationship (Ctrl). Specifically, it is determined that there is a control dependency relationship (Ctrl) between a statement of a processing instruction beginning from line 35, character 17 “test(&v[0],&w[0],&x[0],&y[0],&z[0])” and a statement of a processing instruction beginning from line 1, character 1 “int test(int*p_in,int*q_in,int*r_in,int*s_in,int*w_out){” in the program 21 of FIG. 2.

3.1.3 Pointer Dependency Relationship Analysis

The pointer analyzing unit 54 analyzes and determines whether or not there is a pointer dependency relationship (Ptr), based on information on pointers, from the information on the control flow graph (CFG). For example, it is determined that there is a pointer dependency relationship (Ptr) between a statement of “w[i]=k;” on line 24 and the statement of “a=p[i];” on line 15 in the for statement in the program 21 of FIG. 2. In other words, since it is unknown whether respective pointers of “w[i]” and “p[i]” point the same position on the memory, it is determined that there is, or there may be a possibility of a pointer dependency relationship (Ptr).

Resultant information in the process in the control dependency relationship analyzing unit 53 is outputted and registered as control dependency relationship information 53a in the inter-statement dependency relationship information database 12b.

Furthermore, the resultant information in the control dependency relationship analyzing unit 53 is supplied to two determinacy analyzing units 55 and 56.

3.1.4 Determinacy Analysis

From information from the variable definition/usage analyzing unit 52 and information on the determinacy from the determinacy analyzing unit 55, dependency relationship information for the data dependency (hereinafter also referred to as “data dependency relationship information”) 52a is generated. Moreover, from information from the pointer analyzing unit 54 and information on the determinacy from the determinacy analyzing unit 56, dependency relationship information for the pointer dependency (hereinafter also referred to as “pointer dependency relationship information”) 54a is generated. The data dependency relationship information 52a and the pointer dependency relationship information 54a are also outputted and registered in the inter-statement dependency relationship information database 12b.

Here, the determinacy analysis will be described. The determinacy analysis is executed in the determinacy analyzing units 55 and 56 and the control dependency relationship analyzing unit 53. The determinacy analyzing units 55 and 56 and the control dependency relationship analyzing unit 53 configure a determinacy determining unit configured to determine the determinacy in at least one dependency relationship of the data dependency, the control dependency and the pointer dependency in the program, respectively.

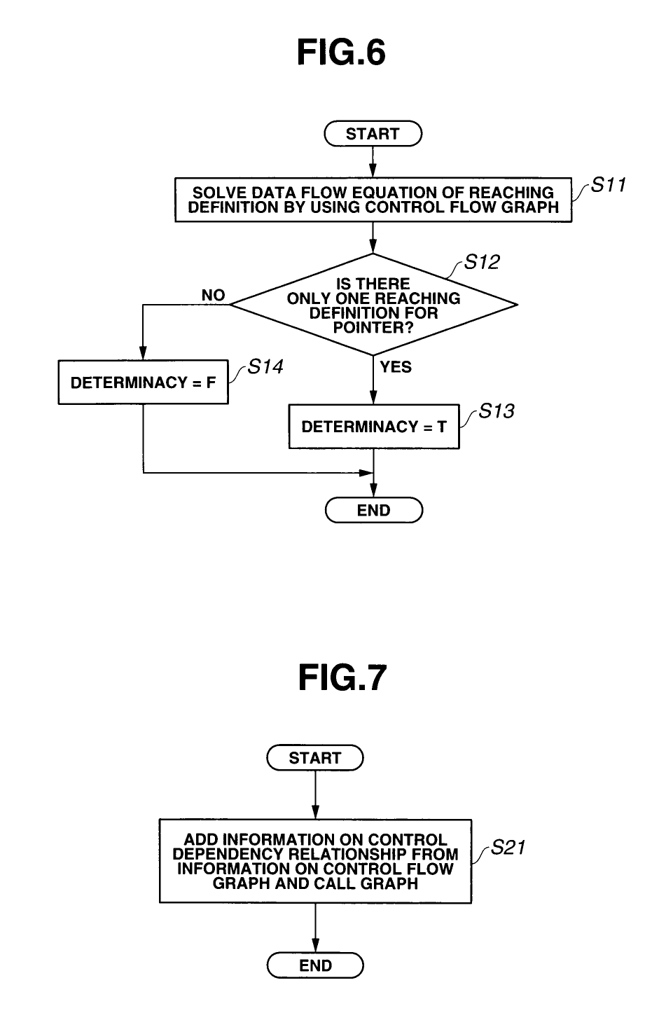

FIG. 6 is a flowchart showing an example of a flow of a process related to the determination of the determinacy in the determinacy analyzing unit 55.

First, a process of solving a data flow equation of a reaching definition is executed by using the control flow graph (CFG) (step S11). With a result of solving the equation, it is determined whether or not there is only one reaching definition for the pointer (step S12). At step S12, in simple terns, it is determined whether or not data in the memory pointed by the pointer of the variable is definite data.

In the case of YES at step S12, the determinacy becomes T for “True”, (step S13). In the case of NO at step S12, the determinacy becomes F for “False” (step S14). In the case of the above described FIG. 2, since it is unknown whether the respective pointers of w[i] and p[i] point the same position on the memory, it is determined that there may be a possibility of a data dependency relationship (Data), that is, there is a data dependency relationship (Data). The information on the determinacy is registered in the inter-statement dependency relationship information database 12b. For example, on line 1 of FIG. 4, the dependency type is “Data” and the determinacy is “T”.

FIG. 7 is a flowchart showing an example of a flow of a process related to the determination of the determinacy in the control dependency relationship analyzing unit 53.

In FIG. 7, from the generated information on the control flow graph (CFG) and the call graph (CG), information on the control dependency relationship (Ctrl) is registered in the inter-statement dependency relationship information database 12b. For example, on line 2 of FIG. 4, the dependency type is “Ctrl” and the determinacy is “T”.

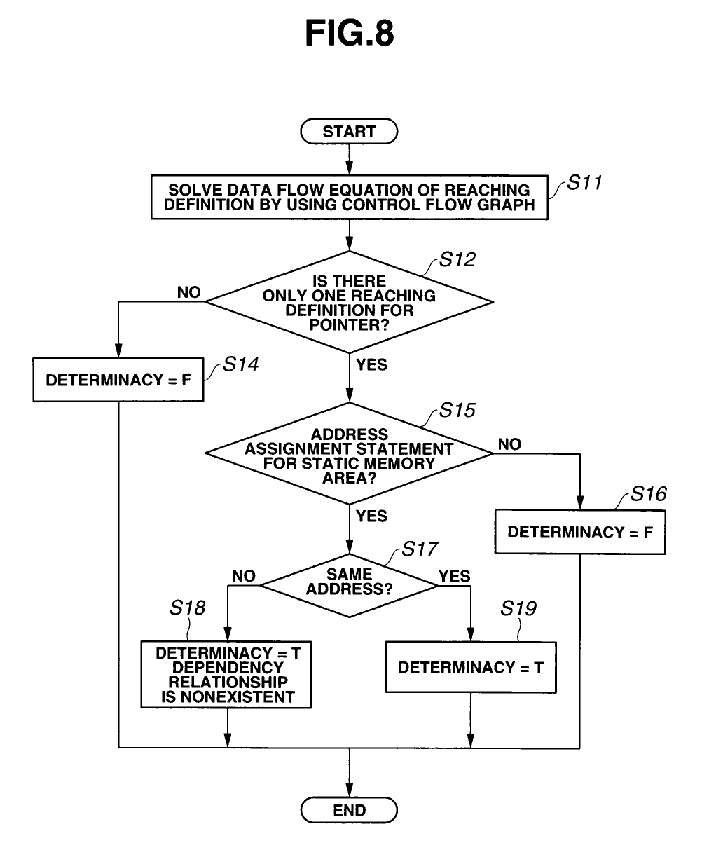

FIG. 8 is a flowchart showing an example of a flow of a process related to the determination of the determinacy in the determinacy analyzing unit 56.

In FIG. 8, since contents of steps S11 and S12 are the same as those of the process in FIG. 6, descriptions thereof are omitted.

In the case of YES at step S12, it is determined whether or not the statement is an address assignment statement for a static memory area (step S15).

In the case of NO at step S15, the determinacy becomes “nonexistent”, that is, F (False) (step S16).

In the case of YES at step S15, it is determined whether the definition is the same address (step S17).

In the case of NO at step S17, the determinacy becomes “existent”, that is, T (True) (step S18). However, in that case, since the pointer dependency relationship (Ptr) becomes “nonexistent”, the information is not registered in the inter-statement dependency relationship information database 12b.

In the case of YES at step S17, the pointer dependency relationship (Ptr) becomes “existent”, and the determinacy becomes “existent”, that is, T (True) (step S19). For example, on line 3 of FIG. 4, the dependency type is “Ptr” and the determinacy is “F”.

As described above, the data in the items of the fields from 41a to 41i in the inter-statement dependency relationship information database 12b of FIG. 4 is recorded.

Here, returning to FIG. 3, the process moves to a critical path analyzing process.

3.2 Critical Path Analysis

The critical path analyzing process is performed by a critical path analyzing and extracting unit 32.

In the critical path analyzing and extracting unit 32, the program 21 is analyzed, a path with the largest number of processing units in multiple paths from the beginning to the end of the program, that is, a critical path (CP) is extracted, and it is determined whether or not the statement of each piece of dependency relationship information registered in the inter-statement dependency relationship information database 12b of FIG. 4 exists on the extracted critical path (CP).

Then, for the field of the critical path 41j, data is registered as T for “True”, if the statement exists on the extracted critical path, or as F for “False”, if the statement does not exist on the extracted critical path, in the inter-statement dependency relationship information database 12b.

Next, the process moves to a parallelization possibility analysis.

3.3 Parallelization Possibility Analysis

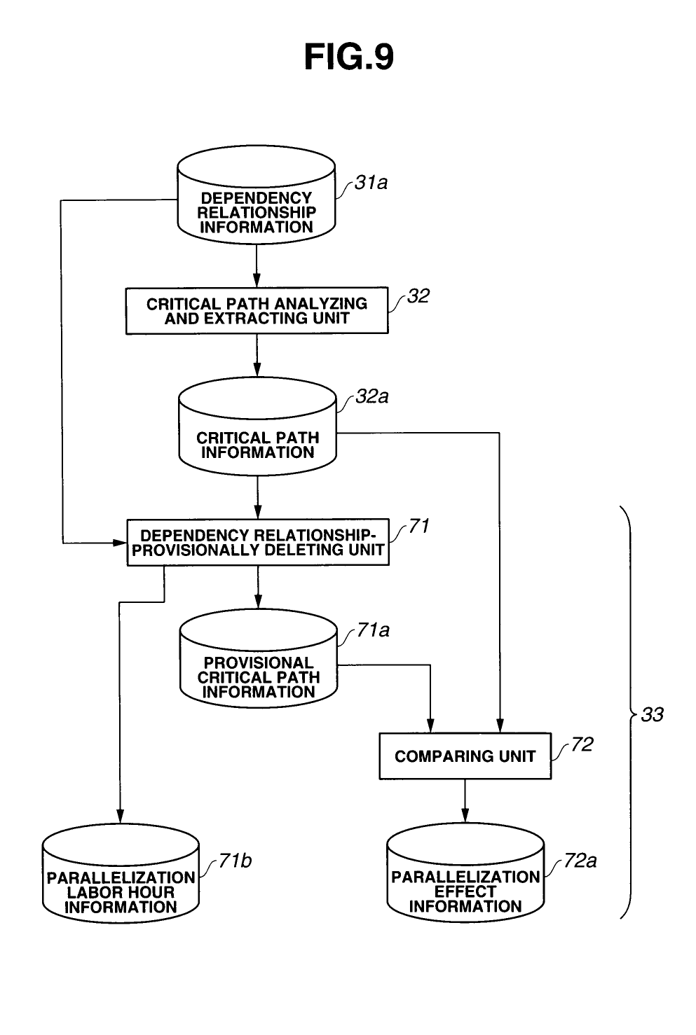

The parallelization possibility analysis is performed by a parallelization possibility analyzing unit 33. FIG. 9 is a diagram illustrating processing contents in the parallelization possibility analyzing unit 33.

FIG. 9 includes contents of two processes in the critical path analyzing and extracting unit 32 and the parallelization possibility analyzing unit 33. The critical path analyzing and extracting unit 32 calculates and obtains a critical path (CP) from the dependency relationship information in the dependency relationship information 31a, as described above.

The parallelization possibility analyzing unit 33 includes a dependency relationship-provisionally deleting unit 71 and a comparing unit 72. The dependency relationship-provisionally deleting unit 71 extracts the dependency relationship information with the determinacy of “F” on the critical path (CP) from information on the critical path (CP) (hereinafter referred to as “critical path information”) 32a and the dependency relationship information 31a. In other words, the dependency relationship-provisionally deleting unit 71 configures a processing instruction extracting unit configured to extract a processing instruction which exists on the critical path (CP) and has a non-deterministic determinacy in the dependency relationship.

Then, for each piece of the extracted dependency relationship information, the dependency relationship-provisionally deleting unit 71 provisionally deletes the dependency relationship, calculates a provisional critical path (PCP) in the case where the provisional deletion has been performed, and outputs the provisional critical path as provisional critical path information 71a. Therefore, the dependency relationship-provisionally deleting unit 71 configures a provisional critical path extracting unit configured to extract the provisional critical path in the program 12a in the case where a path section of the extracted non-deterministic processing instruction has been parallelized and provisionally deleted.

The comparing unit 72 compares the critical path information 32a with the provisional critical path information 71a, and outputs resultant information from the comparison, as information on the parallelization effect in the inter-statement dependency relationship information database 12b. Parallelization effect information 72a is recorded in the field of the parallelization effect 41k.

The parallelization effect information 72a is information on an amount indicating how much of the processing unit is reduced if a statement, that is, a processing instruction, including the dependency relationship has been applied with a parallelization process. In other words, the parallelization effect information 72a is information on a difference between the critical paths extracted in the critical path analyzing and extracting unit 32 and the dependency relationship-provisionally deleting unit 71, respectively, before and after the deletion of the non-deterministic processing instruction. The parallelization effect information 72a will be specifically described below.

Furthermore, parallelization labor hour information 71b is calculated in the dependency relationship-provisionally deleting unit 71 and outputted to the inter-statement dependency relationship information database 12b.

Upon the parallelization of the statement, the dependency relationship of which is determined as non-deterministic, that is, the processing instruction, if there are other paths for which the dependency relationships must be accordingly eliminated and the parallelization process must be performed, the parallelization labor hour information 71b is information indicating the labor hours for the parallelization also including the number of the other paths. In other words, the parallelization labor hour information 71b is information on the number of paths of the dependency relationships for which the parallelization needs to be realized simultaneously if the non-deterministic processing instruction is parallelized. The parallelization labor hour information 71b will also be specifically described below.

The comparing unit 72 configures a parallelization information outputting unit configured to, if a process related to the path of the extracted non-deterministic processing instruction is parallelized and the path of the non-deterministic processing instruction is deleted, output the parallelization labor hour information depending on the number of dependency relationships disturbing the parallelization and the parallelization effect information depending on the number of processing instructions which are shortened by the parallelization.

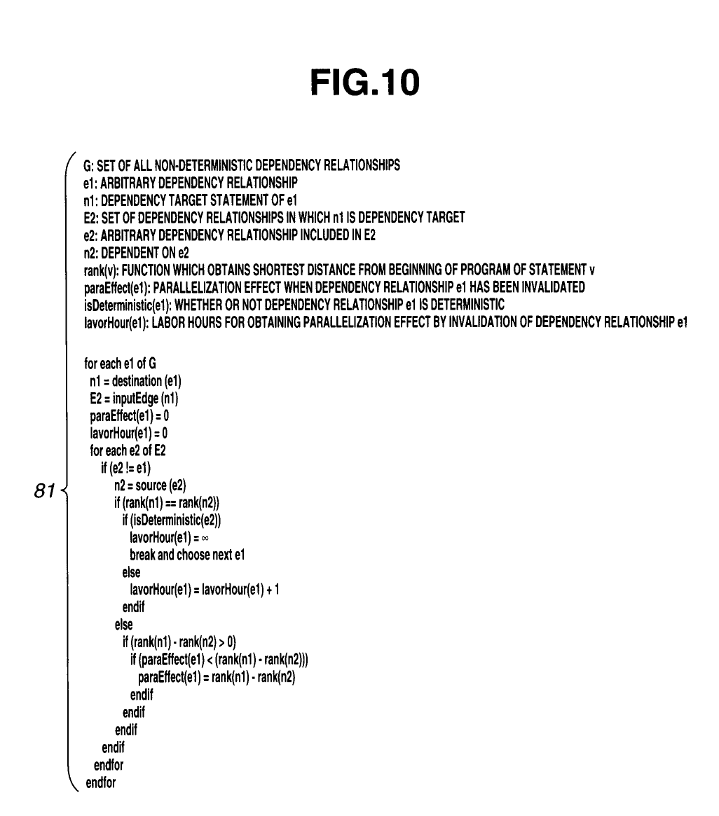

It should be noted that FIG. 10 is a diagram showing an example of a processing program 81 in the parallelization possibility analyzing unit 33 shown in FIG. 9.

As described above, when the program 12a has been inputted and the process as described above has been performed, the parallelization supporting apparatus 1 according to the present embodiment outputs the parallelization labor hour information 71b and the parallelization effect information 72a. The output of the parallelization labor hour information 71b and the parallelization effect information 72a is, for example, outputted onto a screen of the displaying device 13. Hence, the user can recognize the parallelization labor hour information 71b and the parallelization effect information 72a. As a result, the user can perform a task of the parallelization process in consideration of an amount of load of the parallelization task and the parallelization effect.

3.4 Usage Pattern Example of Parallelization Supporting Apparatus

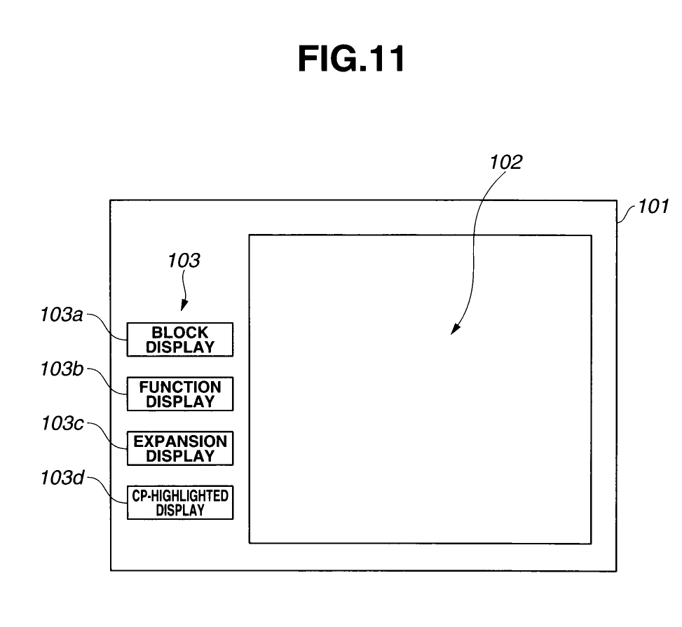

Next, an example of the screen of the displaying device 13 of the parallelization supporting apparatus 1 will be described. FIG. 11 is a diagram showing a display example of the screen of the displaying device 13 of the parallelization supporting apparatus 1.

As a result of the processes in the critical path analyzing and extracting unit 32 and the parallelization possibility analyzing unit 33 of FIG. 3, the information in the fields of the items from 41j to 41l in the inter-statement dependency relationship information database 12b is added as dependency relationship information 33a for supporting the parallelization. Based on the dependency relationship information also including the added dependency relationship information 33a for supporting the parallelization, the parallelization supporting apparatus 1 can display various dependency relationship graphs, that is, perform dependency relationship diagram display 34a for supporting the parallelization, on the displaying device 13 via a display unit 34. Hence, the display unit 34 configures a dependency relationship graph displaying unit configured to display the dependency relationship in the program as the dependency relationship graph on the displaying device 13.

The parallelization supporting apparatus 1 has an editing function for a dependency relationship. For example, the user can also comprehend and confirm how the dependency relationship and the critical path change on the screen, by using an editing unit 35 to perform an editing task of invalidating the dependency relationship while watching the display of the various dependency relationship graphs, which is the dependency relationship diagram display 34a of FIG. 3. In FIG. 3, the task of invalidating the dependency relationship which is performed by the user is shown as dependency relationship invalidation 35a.

For example, as shown in FIG. 11, on a screen 101 of the displaying device 13 are provided a dependency relationship graph displaying unit 102 configured to display the dependency relationship graph indicating the dependency relationship, which is the dependency relationship diagram display 34a for supporting the parallelization, and multiple display mode button units 103 used for selecting various display modes. The multiple display mode button units 103 configure a graph type selecting unit with which a type of the dependency relationship graph to be displayed on the displaying device 13 can be selected.

The user can display a screen of FIG. 10 by operating the inputting device of the parallelization supporting apparatus 1. On the dependency relationship graph displaying unit 102, the dependency relationship graph depending on each button of the display mode button units 103 is displayed.

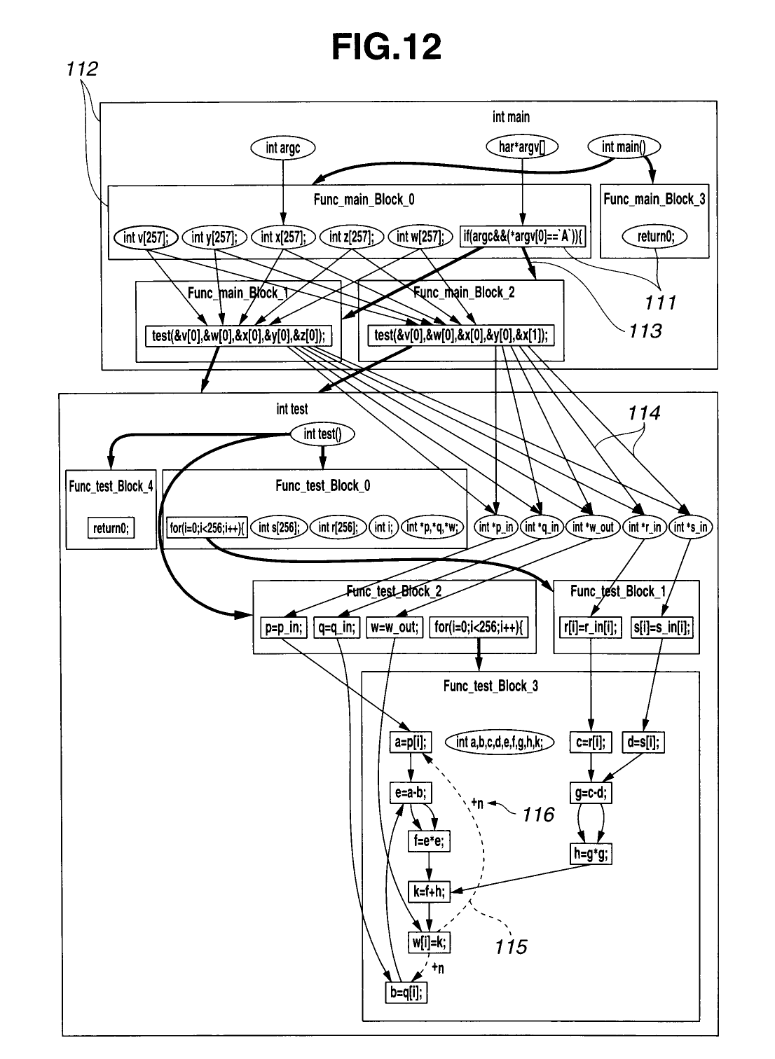

Hereinafter, display examples of the dependency relationship graphs to be displayed on the dependency relationship graph displaying unit 102 will be described. Each of FIGS. 12 to 16 shows an example of the dependency relationship graph as one of the dependency relationship diagram display 34a for supporting the parallelization.

FIG. 12 is a diagram showing a display example of the dependency relationship graph to be displayed on the dependency relationship graph displaying unit 102 of the displaying device 13. When the dependency relationship graph is displayed by using a displaying function of the parallelization supporting apparatus 1, based on the dependency relationship information obtained by analyzing the program 21 of FIG. 2, the dependency relationship graph of FIG. 12 is displayed on the screen 101 of the displaying device 13.

In the dependency relationship graph of FIG. 12, each element drawn as an ellipse and a rectangle represents a statement and each arrow connecting statements represents a dependency relationship. In FIG. 12, for example, an ellipse and a rectangle denoted by reference numeral 111 represent statements. A frame line surrounding one or more statements represents a group of basic blocks and functions. In FIG. 12, for example, frame lines denoted by reference numeral 112 represent groups of the basic blocks or the functions.

A path representing the dependency relationship, that is, the arrow is shown as follows, corresponding to its type and determinacy. The control dependency (Ctrl) is shown by a heavy line, the data dependency (Data) and the deterministic pointer dependency (Ptr) are shown by solid lines, and the non-deterministic one of the pointer dependencies (Ptr) is shown by a dotted line. In FIG. 12, for example, a heavy line denoted by reference numeral 113 represents the control dependency (Ctrl), solid lines denoted by reference numeral 114 represent the data dependency (Data) or the deterministic pointer dependency (Ptr), and a dotted line denoted by reference numeral 115 represents the non-deterministic pointer dependency (Ptr). A distinction between the solid line and the dotted line on the display is determined by using the information on the determinacy in the inter-statement dependency relationship information database 12b. If the information on the determinacy indicates “F”, the arrow is displayed by the dotted line.

Moreover, an arrow representing the dependency with the carry property is added with a label such as “+n” indicating that the arrow represents the dependency with the carry property. In FIG. 12, for example, a section denoted by reference numeral 116 is added with the label “+n”.

The user can see the dependency relationship graph of FIG. 12 to comprehend a structure of the program and the dependency relationships therein.

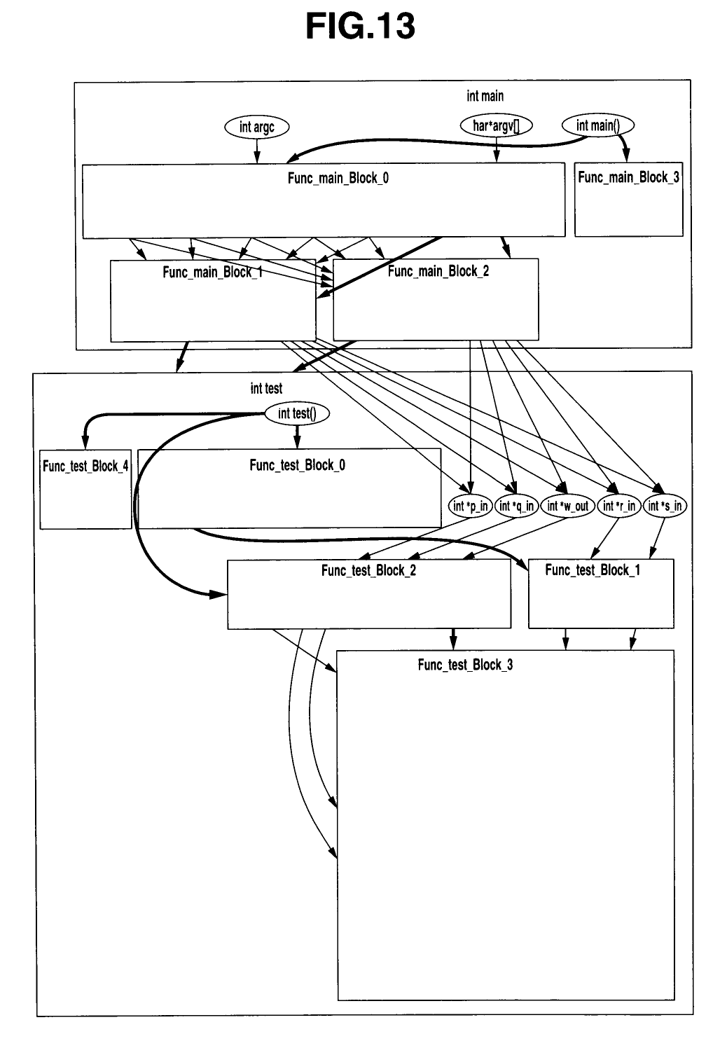

Furthermore, it is possible to draw an arbitrary block in which the display of the dependency relationship between the statements is omitted, on the dependency relationship graph on the screen, by using the displaying function of the parallelization supporting apparatus 1. A screen of FIG. 13 is displayed by clicking, that is, specifying a block display button 103a in FIG. 10. FIG. 13 is a diagram showing a display example of a block level display of the dependency relationship graph.

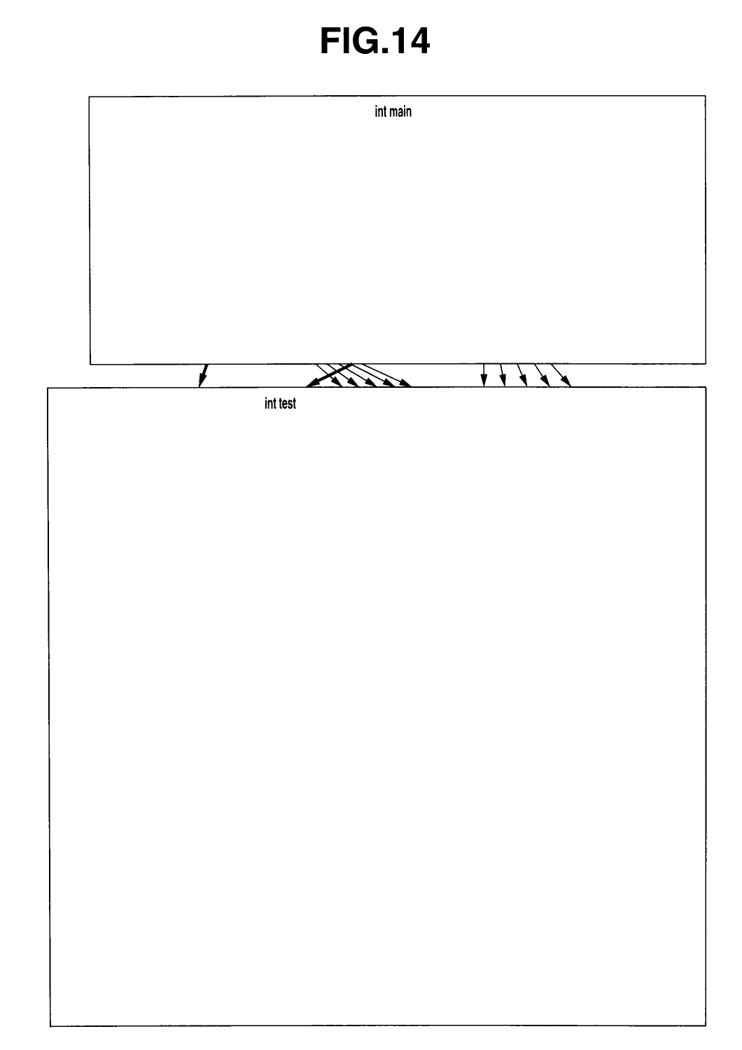

Moreover, a screen of FIG. 14 is displayed by clicking, that is, specifying a function display button 103b in FIG. 10. FIG. 14 is a diagram showing a display example of the dependency relationship graph in which, with respect to arbitrary functions, the display of the dependency relationships of the functions on the dependency relationship graph has been omitted in blocks.

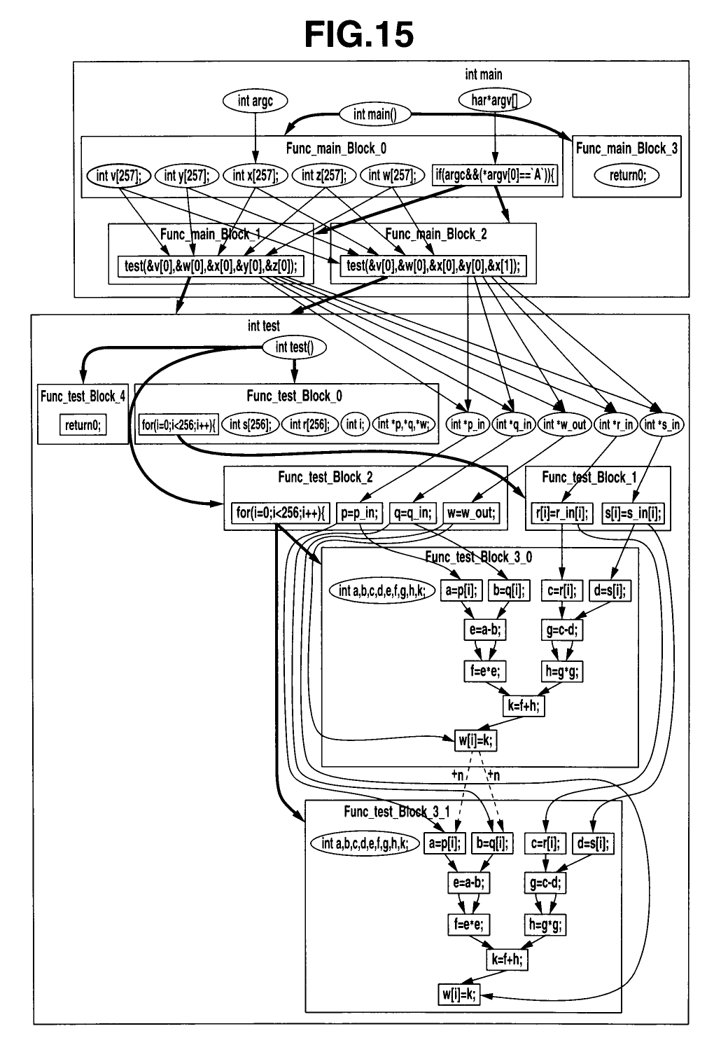

Moreover, a screen of FIG. 15 is displayed by clicking, that is, specifying an expansion display button 103c in FIG. 10. FIG. 15 is a diagram showing a display example of a dependency relationship graph loop two-stage loop expansion display. As shown in FIG. 15, if there is the dependency relationship with the carry property, a basic block including a specified dependency relationship with the carry property is copied, and thereby the dependency relationship with the carry property is displayed as a dependency relationship to the basic block, which has been copied from the basic block. On this occasion, the inter-statement dependency relationship information database 12b of FIG. 4 is also updated automatically.

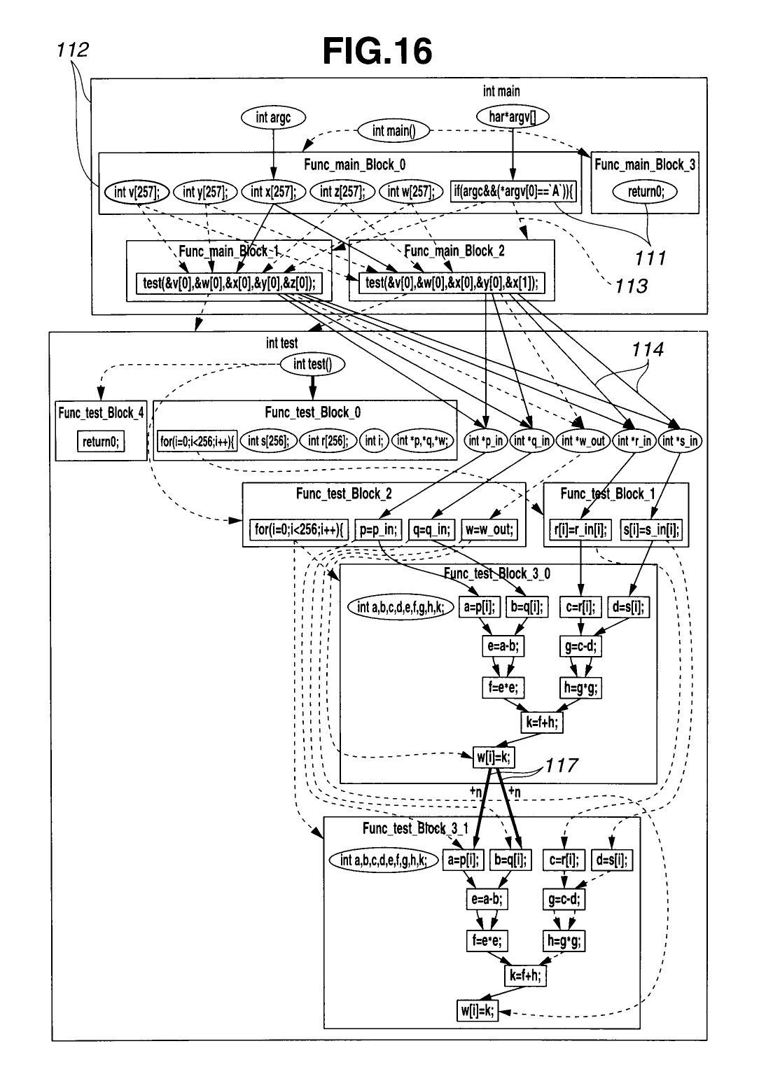

Furthermore, a screen of FIG. 16 is displayed by clicking, that is, specifying a critical path (CP)-highlighted display button 103d in FIG. 10. FIG. 16 is a diagram showing a display example of a critical path-highlighted display. As shown in FIG. 16, it is possible to highlight a path of a dependency relationship on a critical path in execution of a process between two points in the program. Here, the critical path is shown by the solid line. On this occasion, for a path of a non-deterministic dependency relationship in the dependency relationships on the critical path, parallelism of the program may be increased by invalidating the dependency relationship, and therefore, such a path is displayed in a particularly highlighted manner, as denoted by reference numeral 117. The highlighted display is performed by extracting a path related to the statement with the critical path (CP) of “T” and the determinacy of “F”, with reference to the field of the critical path 41j and the field of the determinacy 41i in FIG. 4.

As shown in FIG. 16, the user can easily understand that there is a dependency relationship between one basic block (Func_test_Block_{—}3_{—}0) and another basic block (Func_test_Block_{—}3_{—}1), and if the path of the dependency relationship can be eliminated, the critical path is shortened by the number of unit processes in the basic block (Func_test_Block_{—}3_{—}1), that is, 5 stages. The user can see in FIG. 16 that, since the number of stages of the unit processes in the basic block (Func_test_Block_{—}3_{—}1) is 5, the parallelization effect is 5, and since the number of the highlighted critical paths is 2, the labor hours for the parallelization are 2.

It should be noted that a value of the parallelization effect and a value of the labor hours for the parallelization may be arranged and displayed along the path on the dependency relationship graph in this way, or may be separately displayed as numerical values in another section such as a pop-up window.

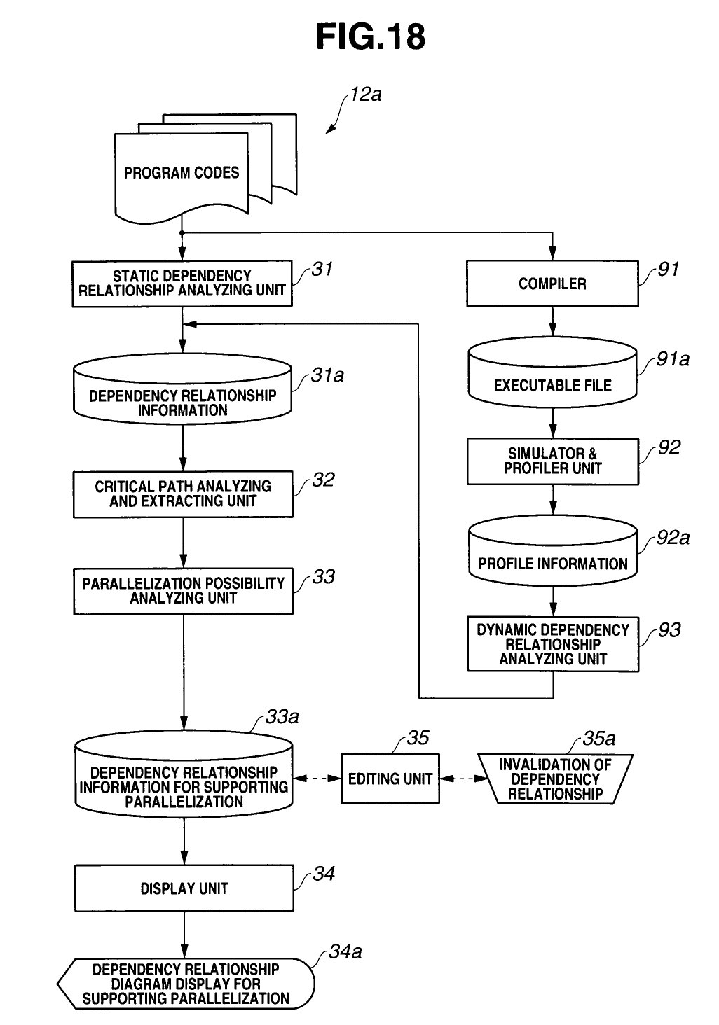

Moreover, the parallelization supporting apparatus 1 has a function, that is, means configured to sort the information on the non-deterministic dependency relationships in the dependency relationships on the critical path (CP), in a descending order of a value obtained by dividing the parallelization effect by the labor hours for the parallelization, that is, in an order from a largest value to a smallest value, and enumerate the information. Since the information is sorted and displayed in a list, it becomes possible to easily find a dependency relationship for which a large parallelization effect can be expected with the invalidation of the dependency relationship with few labor hours. For example, when the dependency relationship information in the inter-statement dependency relationship information database 12b of FIG. 4 is displayed on the screen of the displaying device 13, it is also possible to sort the dependency relationship information in the descending order of the value obtained by dividing the parallelization effect by the labor hours for the parallelization and display the dependency relationship information. The display unit 34 in FIG. 18 configures a processing instruction information outputting unit configured to output information on the processing instruction with the non-deterministic determinacy in the dependency relationship, in a descending order of a value obtained by dividing a value of the parallelization effect information by a value of the parallelization labor hour information.

The parallelization supporting apparatus 1 has the editing function, and with the editing function, it is possible to select and invalidate an arbitrary non-deterministic dependency relationship in the dependency relationships on the dependency relationship graph by the editing unit 35. For example, it is possible to select a line of a desired dependency relationship on the screen by using the inputting device such as a mouse, perform a predetermined operation, and thereby perform the invalidation thereof. For the invalidated dependency relationship, a value or information indicating invalidity is recorded in the field of the item of the validity 41m in the inter-statement dependency relationship information database 12b. With the editing function of the present embodiment, it is possible to extract only the invalidated dependency relationship and validate an arbitrary dependency relationship again. It should be noted that the invalidation of the deterministic dependency relationship is prohibited by the editing function of the present embodiment. Hence, the editing unit 35 configures a dependency relationship graph editing unit with which the line of the displayed dependency relationship graph can be selected and predetermined editing can be performed.

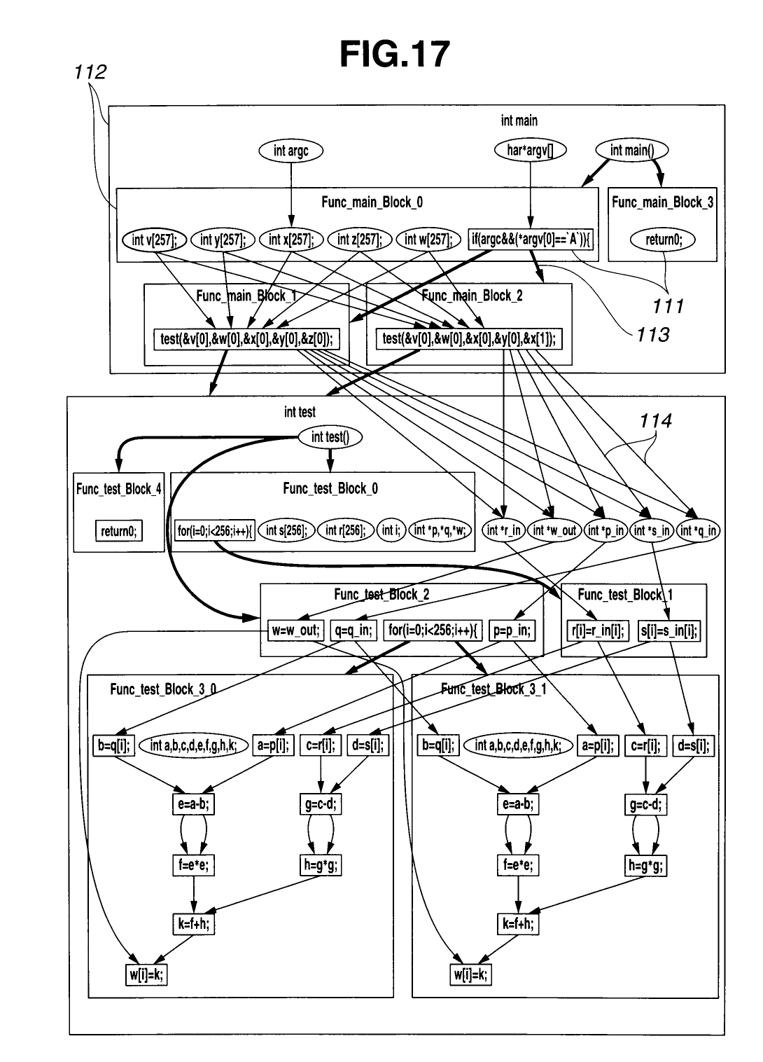

With the displaying function of the present embodiment, for example, when the user changes the validity/invalidity of the dependency relationship on the screen, the critical path (CP) is recalculated, the inter-statement dependency relationship information database 12b is provisionally updated, and the dependency relationship graph is redrawn. Whether or not provisional invalidation of the dependency relationship has been effective for improvement in the parallelism can be immediately known as shown in FIG. 17. FIG. 17 is a diagram showing a display example of the dependency relationship graph after the dependency relationship has been invalidated.

Therefore, when the program 21 is inputted, the parallelization supporting apparatus 1 executes the static dependency relationship analysis, the critical path analysis and the parallelization possibility analysis. As a result, the inter-statement dependency relationship information database 12b is provisionally updated, and the user can easily comprehend a section for which the parallelization can be effectively performed in the program 21, by seeing the information on the parallelization effect and the labor hours for the parallelization. Particularly, if a sorting function as described above is used, the parallelization task can be performed more effectively and efficiently.

Furthermore, based on the inter-statement dependency relationship information database 12b of FIG. 4, it is possible to display the dependency relationship graph in various patterns on the screen and also easily edit the dependency relationship graph, which thereby enables the user to easily perform an efficient parallelization task.

### Second Embodiment

Next, a second embodiment of the present invention will be described.

In the first embodiment, if the dependency relationship is not deterministic, the field of the determinacy in the dependency relationship information has been non-deterministic. In other words, if the dependency relationship is non-deterministic, “F” is registered. However, there are also some programs in which the dependency relationship becomes definite only in execution times. Consequently, in the present second embodiment, the program is actually executed on a target multiprocessor, and as a result of the execution, the deterministic dependency relationship is extracted. Then, in the dependency relationship information on the dependency relationships determined as non-deterministic in the static dependency relationship analyzing unit 31, dependency relationship information which can be set as the deterministic dependency relationship is removed from parallelization targets, which thereby enables the user to reduce the dependency relationship information on the parallelization targets. When the target program is large, reduction in targets to be considered for the parallelization possibility leads to improvement in efficiency of the parallelization task.

FIG. 18 is a flowchart showing an example of the flow of the process in the parallelization supporting apparatus 1 according to the present embodiment. In FIG. 18, the same processing contents as those of FIG. 3 are attached with same reference characters and descriptions thereof are omitted.

The program codes 12a are compiled by a compiler 91 and an executable file 91a is generated. Then, profile information 92a is generated by a simulator and profiler unit 92. The simulator and profiler unit 92 is a processing unit including a simulator and a profiler.

The compiler 91 generates the inter-statement dependency relationship information database 12b with the same configuration as that of FIG. 4. In the dependency relationship information with the dependency type of the pointer dependency (Ptr), the compiler 91 adds a predetermined label which can be recognized by the profiler, to assembler codes corresponding to the dependent statement and the dependency target statement. For a memory access instruction added with the label, the profiler outputs a range of addresses accessed in the execution time as profile information. Then, based on the profile information, a dynamic dependency relationship analyzing unit 93 extracts the deterministic dependency relationship information.

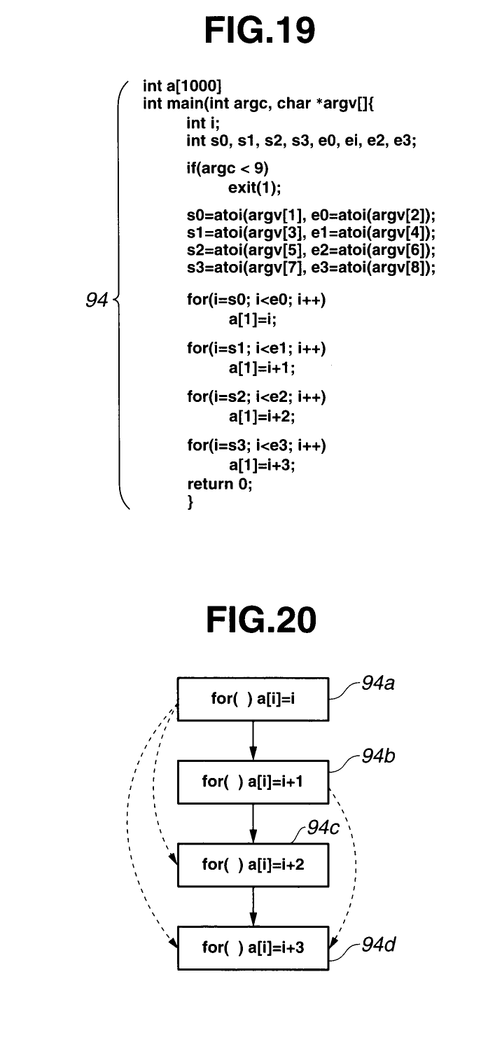

An example will be described. FIG. 19 is a diagram showing an example of a program for which the parallelization is desired. A program 94 of FIG. 19 is a program configured to divide array data a[ ] into four regions and write data in the four regions. Specifically, the program 94 is a program in which an argument “100 200 100 150 500 600 700 800” is given to a program of main, and variables s0 to s3 and variables e0 to e3 are used to write the data in the four regions of the array data a[ ].

The executable file 91a of the program 94 is executed in the simulator and profiler unit 92, and the profile information 92a on each statement is obtained. Therefore, from the profile information 92a, the dependency relationship information is obtained as dynamic dependency relationship information.

FIG. 20 is a diagram illustrating dependency relationship information in which the program 94 has been executed and dependency relationships in the execution of the program have been generated from the profile information 92a. As shown in FIG. 20, it is assumed that, in four for statements, a dependency relationship between a first for statement 94a and a second for statement 94b is deterministic, while other dependency relationships among statements 94a to 94d are non-deterministic.

Then, the dependency relationship information obtained by the static dependency relationship analyzing unit 31 corresponds to the dependency relationship information obtained by the dynamic dependency relationship analyzing unit 93. Hence, in the dependency relationship information which has been obtained by the static dependency relationship analyzing unit 31 and determined to have the non-deterministic determinacy, if there is the dependency relationship information determined to have the deterministic determinacy as a result of the analysis in the dynamic dependency relationship analyzing unit 93, the item of the determinacy in the dependency relationship information determined to have the non-deterministic determinacy as a result of the analysis in the static dependency relationship analyzing unit 31 is changed to “deterministic”, that is, “T”.

As described above, according to the present embodiment, in the dependency relationship information obtained by the static dependency relationship analyzing unit 31, the pointer dependency is corrected by using the dependency relationship information with the deterministic determinacy which has been obtained by the dynamic dependency relationship analyzing unit 93. Thereby, the number of the parallelization targets in the inter-statement dependency relationship information database 12b can be reduced, which thereby improves the efficiency of the parallelization task.

As above, according to the program parallelization supporting apparatus of the above described respective embodiments, it is possible to extract a section of the dependency relationship between the processing instructions for which the parallelization of the program can be efficiently performed.

It should be noted that although the above described dependency relationship is the dependency relationship between the processing instructions, that is, between the statements, the same applies to the above described dependency relationship between the blocks, and in that case, the above described dependency relationship database becomes an inter-block dependency relationship database.

It should be noted that each “unit” in the present specification corresponds to each function of the embodiments and is conceptual, and does not necessarily correspond one-to-one to specific hardware or a specific software routine. Therefore, in the present specification, as described above, a virtual circuit block (unit) with each function of the embodiments is assumed and the embodiments have been described. Moreover, for each step of each procedure in the present embodiment, an execution order thereof may be changed, multiple steps may be simultaneously executed, or each step may be executed in a different order for each execution, unless such executions are not contrary to a property of each step.

Furthermore, all or some of parallelization support processing program codes configured to execute the above described operations are recorded or stored as a computer program product, in a portable medium such as a flexible disk or a CD-ROM, or a storage medium such as a hard disk. The program is read by a computer and all or some of the operations are executed. Alternatively, all or some of the program can be distributed or provided via a communication network. The user can download the program via the communication network and install the program in the computer, or install the program from a recording medium into the computer, and thereby easily realize the parallelization supporting apparatus of the present invention.

The present invention is not limited to the above described embodiments, and various modifications, alterations and the like are possible in a range not changing the gist of the present invention.

What is claimed is:

1. A program parallelization supporting apparatus, comprising:
a determinacy determining unit configured to determine a determinacy in at least one dependency relationship of a data dependency, a control dependency and a pointer dependency in a program;
a critical path extracting unit configured to extract a critical path in the program;
a processing instruction extracting unit configured to extract a processing instruction which exists on the critical path and has a non-deterministic determinacy in the dependency relationship in the determinacy determining unit; and
a parallelization information outputting unit configured to, if a process related to a path of the extracted non-deterministic processing instruction is parallelized and the path of the non-deterministic processing instruction is deleted, output parallelization labor hour information depending on the number of dependency relationships disturbing the parallelization and parallelization effect information depending on the number of processing instructions which are shortened by the parallelization.

2. The program parallelization supporting apparatus according to claim 1, wherein:
the determinacy determining unit determines the determinacy by a static dependency relationship analysis.

3. The program parallelization supporting apparatus according to claim 2, wherein:
the determinacy determining unit determines the determinacy by a dynamic dependency relationship analysis based on profile information on a range of addresses accessed in an execution time of the program, in addition to the determination of the determinacy by the static dependency relationship analysis.

4. The program parallelization supporting apparatus according to claim 1, wherein:
the parallelization effect information is information on a difference between critical paths extracted in the critical path extracting unit before and after the deletion of the non-deterministic processing instruction.

5. The program parallelization supporting apparatus according to claim 1, wherein:
the parallelization labor hour information is information on the number of dependency relationships for which the parallelization needs to be realized simultaneously if the non-deterministic processing instruction is parallelized.

6. The program parallelization supporting apparatus according to claim 1, further comprising:
a processing instruction information outputting unit configured to output information on the processing instruction with the non-deterministic determinacy in the dependency relationship, in a descending order of a value obtained by dividing a value of the parallelization effect information by a value of the parallelization labor hour information.

7. The program parallelization supporting apparatus according to claim 1, further comprising:
a dependency relationship graph displaying unit configured to display the dependency relationship in the program as a dependency relationship graph on a displaying device; and
a dependency relationship graph editing unit with which a line of the displayed dependency relationship graph can be selected and predetermined editing can be performed.

8. The program parallelization supporting apparatus according to claim 7, further comprising:
a graph type selecting unit with which a type of the dependency relationship graph to be displayed on the displaying device can be selected.

9. The program parallelization supporting apparatus according to claim 7, wherein:
the program is divided into multiple blocks in predetermined units, and the at least one dependency relationship includes a dependency relationship among the multiple blocks.

10. A program parallelization supporting method, comprising:
determining a determinacy in at least one dependency relationship of a data dependency, a control dependency and a pointer dependency in a program;
extracting a critical path in the program;
extracting a processing instruction which exists on the critical path and has a non-deterministic determinacy in the dependency relationship; and
if a process related to a path of the extracted non-deterministic processing instruction is parallelized and the path of the non-deterministic processing instruction is deleted, outputting parallelization labor hour information depending on the number of dependency relationships disturbing the parallelization and parallelization effect information depending on the number of processing instructions which are shortened by the parallelization.

11. The program parallelization supporting method according to claim 10, wherein:
the determinacy is determined by a static dependency relationship analysis.

12. The program parallelization supporting method according to claim 11, wherein:
the determinacy is determined by a dynamic dependency relationship analysis based on profile information on a range of addresses accessed in an execution time of the program, in addition to the determination of the determinacy by the static dependency relationship analysis.

13. The program parallelization supporting method according to claim 10, wherein:
the parallelization effect information is information on a difference between critical paths extracted before and after the deletion of the non-deterministic processing instruction.

14. The program parallelization supporting method according to claim 10, wherein:
the parallelization labor hour information is information on the number of dependency relationships for which the parallelization needs to be realized simultaneously if the non-deterministic processing instruction is parallelized.

15. The program parallelization supporting method according to claim 10, wherein:
information on the processing instruction with the non-deterministic determinacy in the dependency relationship is outputted in a descending order of a value obtained by dividing a value of the parallelization effect information by a value of the parallelization labor hour information.

16. The program parallelization supporting method according to claim 10, wherein:
the dependency relationship in the program is displayed as a dependency relationship graph on a displaying device; and
a line of the displayed dependency relationship graph can be selected and predetermined editing can be performed.

17. The program parallelization supporting method according to claim 16, wherein:
a type of the dependency relationship graph to be displayed on the displaying device can be selected.

18. The program parallelization supporting method according to claim 16, wherein:
the program is divided into multiple blocks in predetermined units, and the at least one dependency relationship includes a dependency relationship among the multiple blocks.

19. A recording medium having stored therein a program for program parallelization support, comprising:
a first code unit configured to determine a determinacy in at least one dependency relationship of a data dependency, a control dependency and a pointer dependency in a program;
a second code unit configured to extract a critical path in the program;
a third code unit configured to extract a processing instruction which exists on the critical path and has a non-deterministic determinacy in the dependency relationship; and
a fourth code unit configured to, if a process related to a path of the extracted non-deterministic processing instruction is parallelized and the path of the non-deterministic processing instruction is deleted, output parallelization labor hour information depending on the number of dependency relationships disturbing the parallelization and parallelization effect information depending on the number of processing instructions which are shortened by the parallelization.
